(19) United States
(12) Patent Application Publication
(10) Pub. No.: US 2013/0082907 A1
(43) Pub. Date: Apr. 4, 2013

(54) DISPLAY APPARATUS INCLUDING A PATTERN AND METHOD FOR GENERATING A

(71) Applicants: Samsung Electronics Co., Ltd., Gyeonggi-do (KR); Korea University Research and Business Foundat, Seoul (KR)

(72) Inventors: In-Kuk YUN, Gyeonggi-do (KR); Chang-Su Kim, Seoul (KR); Chul-Woo Lee, Seoul (KR); Won-Dong Jang, Seoul (KR); Seong-Min Seo, Gyeonggi-do (KR); Jeong-Seok Lee, Gyeonggi-do (KR); Jeong-Seok Choi, Gyeonggi-do (KR); Yeong-Jun Koh, Seoul (KR)

(73) Assignees: Korea University Research and Business Foundation, Seoul (KR); Samsung Electronics Co., Ltd., Gyeonggi-do (KR)

(21) Appl. No.: 13/628,645

(22) Filed: Sep. 27, 2012

(30) Foreign Application Priority Data
Sep. 29, 2011 (KR) 10-2011-0099423

(51) Int. Cl. G09G 3/20

(52) U.S. Cl. 345/55

(57) ABSTRACT

A display apparatus is provided that includes a plurality of color filters corresponding to subpixels forming pixels of the display apparatus, and a black matrix formed among the plurality of color filters. The plurality of color filters includes a pattern indicating an absolute location of each pixel of the display apparatus.

### PRIORITY

This application claims the priority under 35 U.S.C. §119(a) to Korean Application Serial No. 10-2011-0099423, which was filed in the Korean Intellectual Property Office on Sep. 29, 2011, the entire content of which is hereby incorporated by reference.

### BACKGROUND OF THE INVENTION

1. Field of the Invention

The present invention relates generally to a display apparatus, and more particularly, to a display apparatus including a pattern and a method for generating a pattern in a display apparatus.

2. Description of the Related Art

Currently, various display apparatuses are available, which recognize an input when a user directly touches a display screen with a finger gesture or a touch pen, or performs a corresponding gesture.

More recently, a scheme has been developed for a display apparatus, wherein a location on a display screen is sensed by recognizing a pattern, and inputting is performed based on the sensed location. Specifically, the scheme based on pattern-recognition recognizes a pattern formed on a display by using an inputting device equipped with a camera, such as an electronic-pen, detects a location of the electronic-pen, and performs inputting based on the detected location value. The inputting scheme captures a display formed on a region indicated by the electronic-pen through use of the camera that captures an image in from the point of the electronic-pen, detects a prearranged pattern from the captured image, and recognizes a location or a command indicated by the prearranged pattern.

FIG. 1 illustrates a pattern formed in a display apparatus for a conventional electronic-pen inputting scheme. Specifically, FIG. 1 illustrates a conventional example of a pattern that is formed by disposing circular dots 2 in a prearranged shape on a digital paper 1, using a paint that absorbs an Infra Red (IR) light source.

Referring to FIG. 1, the digital paper 1 has a two-dimensional plane including an X axis and a Y axis, and includes raster lines, i.e., K0 through K7, in a direction of the X axis and R0 through R8 in a direction of the Y axis. The raster refers to a two-dimensional array representing an image, and the circular dots 2 may be disposed based on the raster line. Accordingly, each of the circular dots 2 has a value for indicating a location of a predetermined region.

FIG. 1 provides an example using a scheme that defines digitized coordinates based on a predetermined interval, captures 4×4 blocks or more, and extracts coordinates from the captured image so as to recognize a location. For example, when a pattern of circular dots of a 4×4 block as included in region F0, 0 is recognized and a location of the region F0 is determined.

Although overlapping regions may exist, recognition with respect to overlapping blocks as shown in region 5a and region 5b may be available.

FIG. 2 illustrates an example of a location of a circular dot in a pattern formed in a display apparatus for a conventional electronic-pen inputting scheme.

Referring to FIG. 2, a circular dot 7 in a conventional pattern is disposed to be close to a point 6 where horizontal and vertical raster lines 8 intersect, and a value of the circular dot 7 may be determined based on a distance between the corresponding intersecting point 6 and the circular dot 7 and locational directions of the corresponding intersecting point 6 and the circular dot 7, such that the value may be used for determining the location.

The digital paper 1 corresponds to a paper-based scheme. Accordingly, the digital paper 1 on which a pattern is printed may need to be attached on the display device, e.g., a liquid crystal display (LCD). However, there is a drawback in that an electronic-pen may not be usable in a region where the digital paper 1 is not attached.

In general, the LCD panel is formed of a subpixel corresponding to one of color filters from among an R color filter, a G color filter, and a B color filter, and a black matrix. When the digital paper 1 is attached on a surface of the display panel, the display panel becomes thicker. Also, when a subpixel is covered by the digital paper 1, luminance of the display is deteriorated.

Additionally, when a material that reflects an IR light source, as opposed to a paint that absorbs the IR, is used for producing the pattern of the digital paper 1, the subpixel of the display may be affected, deteriorating a contrast ratio and luminance.

A size of a screen of the display apparatus has been increased and a resolution has been more and more increased and thus, an amount of information to be used for recognizing a location indicated by an electronic-pen in the display screen has been also increased. Therefore, in a display apparatus having a huge size and a high resolution, a code pattern for recognizing information associated with a location of an electronic-pen may need to be information-intensive. For example, although the Full High Definition (FHD) level display apparatuses have recently become very popular, the Ultra High Definition (UHD) level display apparatuses will occupy the next generation market. For location information corresponding to about ten million pixels, such as in the UHD level display, a code pattern may need to be more information-intensive.

However, because the conventional method that uses the digital paper 1 is associated with a physical manufacturing scheme, it may be inefficient to manufacture an information-intensive code pattern. When a portion of the code pattern of the digital paper 1 lost or has an error value, it will be difficult to check the loss and the error.

Further, the conventional method that uses the digital paper 1 may use only a predetermined pattern once the pattern is determined and thus, technology leakages may readily occur.

### SUMMARY OF THE INVENTION

Accordingly, an aspect of the present invention is to solve at least the above-described problems occurring in the prior art, and to provide at least the advantages described below.

An aspect of the present invention is to provide a display apparatus including a pattern that does not affect a thickness of a display panel and secures luminance and a contrast ratio of a display screen, when an input is received in the display apparatus.

An aspect of the present invention is to provide a method for generating a display apparatus including a pattern that does not affect a thickness of a display panel and secures luminance and a contrast ratio of a display screen, when an input is received in the display apparatus.

Another aspect of the present invention is to provide a large screen, high resolution display apparatus including a pattern representing location information of a pixel.

Another aspect of the present invention is to provide a method for generating a large screen, high resolution display apparatus including a pattern representing location information of a pixel.

Another aspect of the present invention is to provide a display apparatus including a pattern for checking an error when a portion of the pattern indicating a location of a pixel is lost or has an error.

Another aspect of the present invention is to provide method for generating a display apparatus including a pattern for checking an error when a portion of the pattern indicating a location of a pixel is lost or has an error.

Another aspect of the present invention is to provide a display apparatus including an encrypted pattern that is resistant to decrypting and prevents leakage of technology associated with the pattern.

Another aspect of the present invention is to provide a method for generating a display apparatus including an encrypted pattern that is resistant to decrypting and prevents leakage of technology associated with the pattern.

In accordance with an aspect of the present invention, a display apparatus is provided. The apparatus includes a plurality of color filters corresponding to subpixels forming pixels of the display apparatus, and a black matrix formed among the plurality of color filters. The plurality of color filters includes a pattern indicating an absolute location of each pixel of the display apparatus.

In accordance with another aspect of the present invention, a method for generating a pattern in a display apparatus is provided. The method includes determining a basic pattern block size to indicate an absolute location of a pixel on a display panel of the display apparatus, determining points where a plurality of holes are to be formed in subpixels included in each block region determined based on the basic pattern block size, where the plurality of holes are used for calculating an absolute location of a corresponding pixel, and generating the pattern by forming a corresponding hole in each point based on an absolute location of a pixel included in each block region, among the points where the plurality of holes are to be formed.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating a pattern formed in a display apparatus for a conventional electronic-pen inputting scheme;

FIG. 2 is a diagram illustrating an example of a location of a circular dot in a pattern formed in a display apparatus for a conventional electronic-pen inputting scheme;

FIG. 3 is a sectional diagram illustrating a liquid crystal panel of a display apparatus according to an embodiment of the present invention;

FIG. 4 is a diagram illustrating subpixel regions and a black matrix region according to an embodiment of the present invention;

FIG. 5 is a diagram illustrating a pattern to be used for determining a location of a pixel based on subpixel regions and a black matrix region according to an embodiment of the present invention;

FIG. 6 is a diagram illustrating a detailed example in which holes are disposed according to an embodiment of the present invention;

FIGS. 7A and 7B are diagrams illustrating an example of a point corresponding to a hole that is formed in a subpixel according to an embodiment of the present invention;

FIGS. 8A and 8B are diagrams illustrating an example of a shuffle table according to an embodiment of the present invention;

FIG. 9 is a diagram illustrating an example of a shuffle table determining scheme for encrypting position holes according to an embodiment of the present invention;

FIG. 10 is a flowchart illustrating a process of generating a pattern in a display apparatus according to an embodiment of the present invention; and

FIG. 11 is a diagram illustrating an example of a pattern formed to indicate a location of a pixel in a display apparatus according to an embodiment of the present invention.

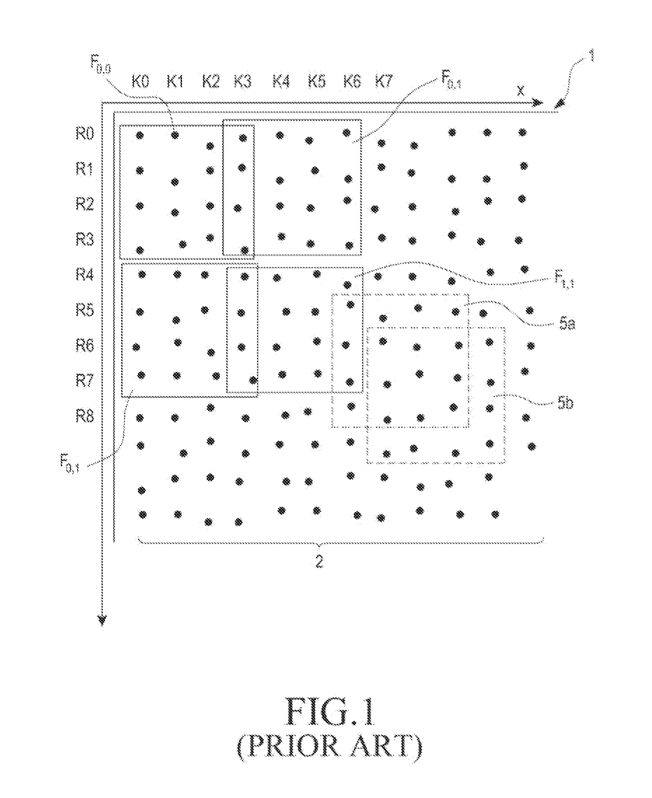

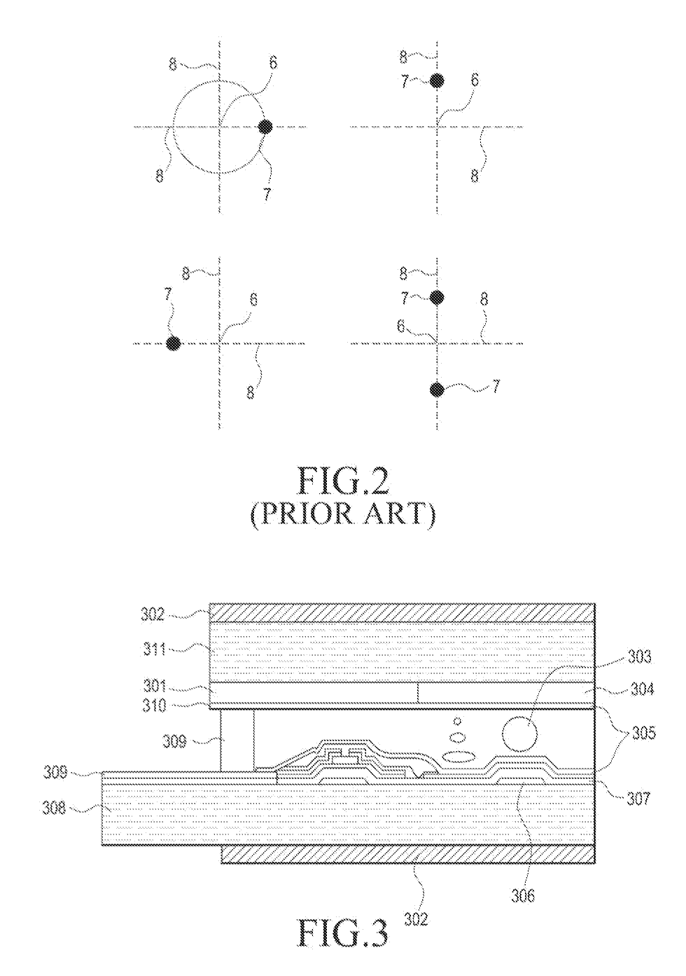

### DETAILED DESCRIPTION OF EMBODIMENTS OF THE INVENTION

Hereinafter, various embodiments of the present invention will be described with reference to the accompanying drawings. In the following description, the same elements will be designated by the same reference numerals although they are shown in different drawings. Further, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

The present invention provides a pattern that is applicable to a display apparatus used in an electronic device such as a portable phone, a computer, an electronic blackboard, a tablet Personal Computer (PC), an electronic-book, etc., and that is used for indicating a location of a pixel of a display panel, and a pattern generating method. In particular, a pattern indicating a location of a pixel formed of subpixels may be formed in the corresponding subpixels of a display apparatus including pixels formed of subpixels (R, G, and B). Therefore, embodiments of the present invention detect a pattern formed in subpixels of a display apparatus by using a camera, and decrypt location and gesture information based on the detected pattern.

For example, the display apparatus corresponds to any device including pixels formed of subpixels, e.g., an LCD, a Plasma Display Panel (PDP), an Organic Light-Emitting Display (OLED), an electronic paper, etc.

FIG. 3 illustrates a section of a liquid crystal panel of a display apparatus according to an embodiment of the present invention.

Referring to FIG. 3, a top polarizing plate 302 is disposed on a topside of the liquid crystal panel, a color filter substrate 311 is disposed below the polarizing plate 302, and a black matrix 301 and a color filter 304 are disposed below the color filter substrate 311. A Thin Film Transistor (TFT) substrate is disposed below the black matrix 301 and the color filter 304.

The TFT substrate includes, a common electrode (Indium Tin Oxide (ITO)) 310 and a pixel electrode (ITO) 307, which are disposed on a TFT-array substrate 308. Two alignment layers 305, a spacer 303, a Capacitance Storage (CS) 306, a sealant 309 are included between the common electrode 310 and the pixel electrode 307. A bottom polarizing plate 302 is disposed below the TFT-array substrate 308.

In accordance with an embodiment of the present invention, the black matrix 301 indicates a boundary in the color filter 304, and includes a material or a structure that absorbs light, or includes a material or a structure that selectively reflects light.

When a light source of an electronic-pen generates an IR light, the black matrix 301 may be formed of carbon black that absorbs IR light.

Also, the color filter 304 may be formed of an R color filter, a G color filter, and B color filter, each of which corresponds to a subpixel. Accordingly, a set of the R, G, and B color filters corresponds to a single pixel.

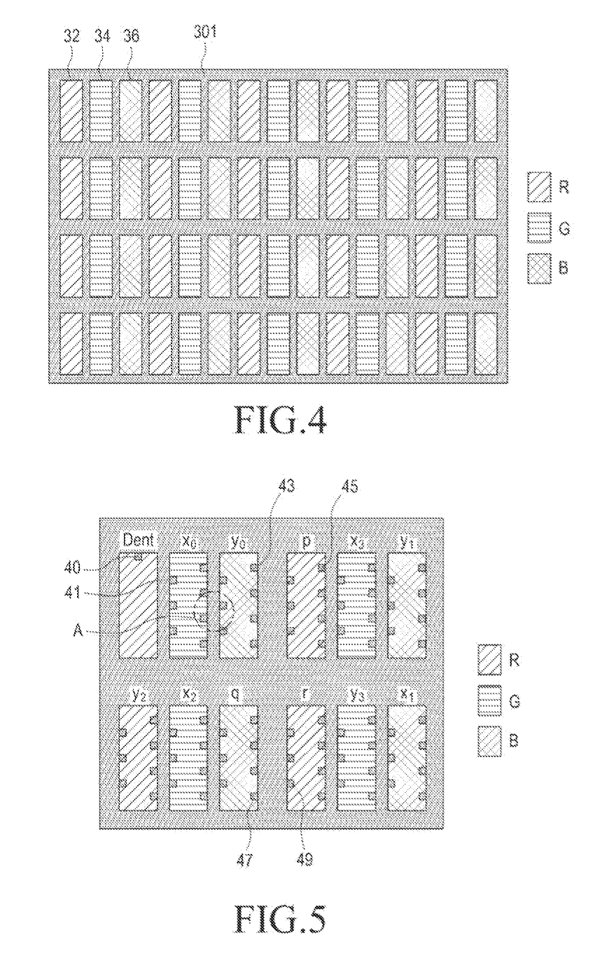

FIG. 4 illustrates subpixel regions and a black matrix region according to an embodiment of the present invention.

Referring to FIG. 4, using the subpixels 32, 34, and 36 and the black matrix 301, a pattern that is capable of determining a location of a pixel may be generated, wherein the location of the pixel may be detected by using an electronic-pen that captures an image including the pattern, and decrypts the pattern in the captured image. A location of an input of the electronic-pen and an input of a gesture are then recognized based on a detected location corresponding to the decrypted pattern.

FIG. 5 illustrates a pattern for determining a location of a pixel based on subpixel regions and a black matrix region according to an embodiment of the present invention.

Referring to FIG. 5, each subpixel, i.e., the R, G, and B subpixels, include at least one hole in a predetermined internal location, based on a pattern that is predetermined for determining a location of a pixel. In FIG. 5, the hole is in a shape formed by leading a black matrix region into each subpixel region. Accordingly, R, G, and B may be formed of the same material as the black matrix region. Also, holes may be formed of another material that may be recognized to be a pattern in R, G, and B regions, and may be disposed in other locations.

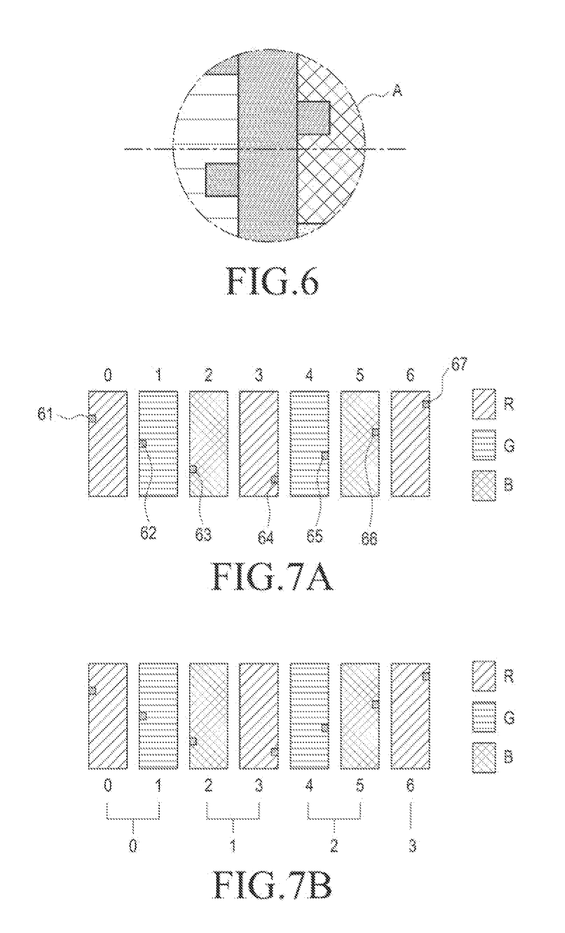

FIG. 6 is a diagram illustrating a detailed example in which holes are disposed according to an embodiment of the present invention.

As illustrated in FIG. 6, it is desirable that holes are separately disposed to have a maximum interval and to not overlap each other so as to be clearly recognized.

Holes included in subpixels may include a dent hole, an X coordinate hole, a Y coordinate hole, and an error detection hole. The dent hole is a reference for calculating an absolute location value of a pixel, and may be formed on a point where the dent hole is readily distinguished from other holes. The X coordinate hole is formed on a point indicating a value to be used for calculating a horizontal-coordinate value of a pixel. The Y coordinate hole is formed on a point indicating a value to be used for calculating a vertical-coordinate value of the pixel. The error detection hole is formed on a point indicating a value to be used for determining whether the points where the X coordinate hole and the Y coordinate hole are formed are correct. The subpixels are include a subpixel including a dent hole, a subpixel including an X coordinate hole, a subpixel including a Y coordinate hole, and a subpixel including an error detection hole.

Referring again to FIG. 5, which illustrates a 2×2 pixel-based pattern structure, a pattern for indicating an absolute location of each of the 2×2 pixels is formed in 12 subpixels included in the 2×2 (4) pixels. Specifically, FIG. 5 illustrates points where holes are to be formed for indicating a pattern corresponding to an absolute location of a pixel of a display apparatus that supports a resolution of up to 4802×2744 in an X coordinate value (width)×a Y coordinate value (height).

Referring to the points where the holes are to be formed, a dent hole 40 is formed on a single subpixel corresponding to a dent subpixel to indicate a reference for calculating an absolute location of a pixel. To support the resolution of 4802×2744, 7 septenary numbers (X0, X1, X2, X3, Y1, Y2, and Y3) and one quaternary number Y0 may be used as the X coordinate value and the Y coordinate value.

When the seven septenary numbers and one quaternary number are used, position holes are formed on the seven points in four subpixels (X0, X1, X2, and X3) for 4802, which is a maximum value for the X coordinate value.

FIGS. 7A and 7B illustrate an example of a point corresponding to a hole that is formed in a subpixel according to an embodiment of the present invention.

Specifically, FIG. 7A illustrates points where holes are to be formed when a septenary number is used.

Referring to FIG. 7A, seven points 61 through 67 indicate points indicating values of 0 through 6, respectively, and an X coordinate value is calculated using Equation (1).

X coordinate value=73×X3+72×X2+7×X1+X0 (1)

Position holes are formed on seven points in four subpixels (Y0, Y1, Y2, and Y3) for 2744, which is a maximum value of a Y value. In this example, the seven points in the subpixels of Y1, Y2, and Y3 indicate values of 0 through 6, respectively, and the values of the seven points in the subpixel of Y0 may be different because the subpixel of Y0 uses a quaternary number.

FIG. 7B illustrates a point where a hole is formed in the subpixel corresponding to Y0.

Referring to FIG. 7B, the seven points in the subpixel corresponding to Y0 have values in a range of 0 through 3. Therefore, the Y coordinate value is calculated using Equation (2).

Y coordinate value=72×4×Y3+7×4×Y2+4×Y1+Y0 (2)

Parity holes are formed on the seven points in three subpixels p, q, and r by applying a parity check scheme to determine whether the points where the X coordinate hole and the Y coordinate hole are formed are correct, i.e., to determine whether an error has occurred. For example, the parity check scheme adds a parity checker bit so that a number of bits indicating 1 in a conventional binary code is an even number of bits or an odd number of bits, and detects an error.

According to an embodiment of the present invention, a septenary number is used and thus, a parity checker may have a value in a range of 0 through 6.

Referring again to FIG. 5, points corresponding to the seven holes in p, q, and r subpixels are points for indicating a parity bit, i.e., a value obtained by adding up values of predetermined position holes. Therefore, the values of p, q, and r are calculated based on parity check equations in Equation (3).

p=modulo7(X3+Y1+X0)

q=modulo7(X2+Y2)

r=modulo7(X1+Y3+Y0) (3)

In Equation (3), the p value is a reference for determining whether an error occurs with respect to values of X3, Y1, and X0, the q value is a reference for determining whether an error occurs with respect to values of X2 and Y2, and the r value is a reference for determining whether an error occurs with respect to values of X1, Y3, and Y0.

Accordingly, when p, q, and r are decoded and a result value of a modulo operation is different from a value of a parity hole, it is determined that an error occurs. Therefore, when an error occurs, error detection may be secured.

The error detection scheme described above may be applied when a location is determined using a partial combination of two basic unit patterns (floating property).

To enable the parity check to be performed based on the floating property, position hole information may be converted based on a location of the parity hole information. For example, when an error occurs in a hole corresponding to a low digit, an error may also occur in a hole corresponding to a high digit of the hole where the error occurs. When only one parity check equation is used, holes including errors may be included in the same parity check equation and thus, may have the same result as when errors occurs in two or more holes.

The problem may be solved using a scheme that includes position holes associated with the same coordinate axis in different parity check equations. Because an X axis and a Y axis have 4 position holes, a total of 4 parity check equations may be required. However, excluding the dent hole and the position holes, available holes may be included in three subpixels and thus, up to 3 parity check equations may be used. Accordingly, position holes associated with the same coordinate axis may be inevitably included in a single parity check equation. Therefore, an error occurring in a position hole corresponding to the lowest digit may have the lowest probability of affecting a position hole corresponding to the highest digit and thus, a scheme that includes the position hole corresponding to the lowest digit and the position hole corresponding to the highest digit in the same parity check equation, as shown in Equation (3), is used.

Although the points and values of holes have been described above, based on a 2×2 pixel-based pattern structure, it is apparent to those skilled in the art that a pattern may be formed based on a single pixel and a pattern may be formed based on various pixel units, such as a 2×3 pixel unit, a 3×3 pixel unit, etc., and a point and a value of a hole may be appropriately used based on a corresponding pixel unit.

The pattern formed in the display apparatus configured as described in the foregoing may have a regular rule and thus, the pattern may be readily decrypted when the rule is recognized. Therefore, in accordance with another embodiment of the present invention, an encrypted pattern is provided so that the pattern formed in the display apparatus may not be easily decrypted without permission. In particular, the pattern may be generated based on a shuffle table so that the generated pattern may not be readily imitated.

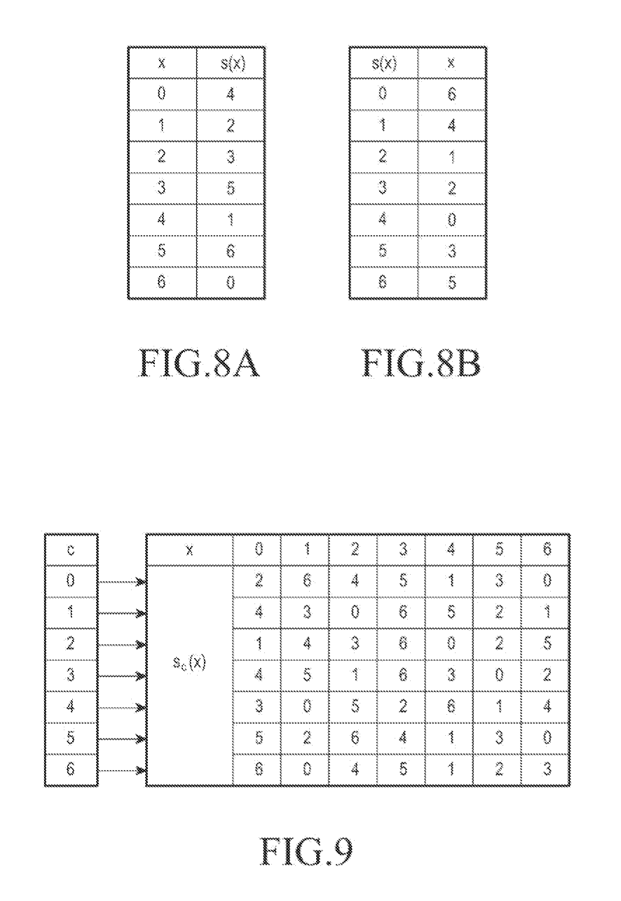

FIGS. 8A and 8B illustrate an example of a shuffle table according to an embodiment of the present invention. Specifically, FIG. 8A illustrates an example of a shuffle table for encrypting, and FIG. 8B illustrates an example of a shuffle table for decrypting.

Referring to FIG. 8A, holes included in each subpixel excluding a dent are formed in locations having values in a range of 0 through 6. Therefore, a shuffle value (s(x)) for converting a value (x) in a range of 0 through 6 may be arranged in a table, and a location of each hole may be converted into a location corresponding to a shuffle value so that an encrypted pattern may be provided. For example, when a point where an original hole is formed corresponds to a point indicating 0, a hole may be formed on a point indicating 4, based on the shuffle table.

In this example, a plurality of shuffle tables may be used, a predetermined shuffle table from among the plurality of shuffle tables may be determined, and the encrypted pattern may be provided. In particular, a predetermined first shuffle table may be used for parity holes of p, q, and r that have a high frequency of change in points where holes are formed and for a position hole of Y0. For remaining holes, a second shuffle table to be applied to the remaining holes may be determined based on the first shuffle table value associated with the parity holes of p, q, and r, and the position hole of Y0, and points where the remaining holes are formed may be converted into points corresponding to values based on the determined second shuffle table.

FIG. 9 illustrates an example of a shuffle table determining scheme for encrypting position holes according to an embodiment of the present invention.

Referring to FIG. 9, c is a shuffle value that is obtained by converting parity holes of p, q, and r, and a position hole of Y0 through use of a first shuffle table, and indicates a reference value for determining a second shuffle table to be applied to remaining holes. Sc(x) indicates the second shuffle table determined based on the reference value. Values for the remaining holes may be determined based on the second shuffle table and an encrypted pattern may be provided. For example, the second shuffle table may be determined based on values of other holes, in addition to a scheme that determines the second shuffle table based on the parity holes of p, q, and r, and the position hole of Y0.

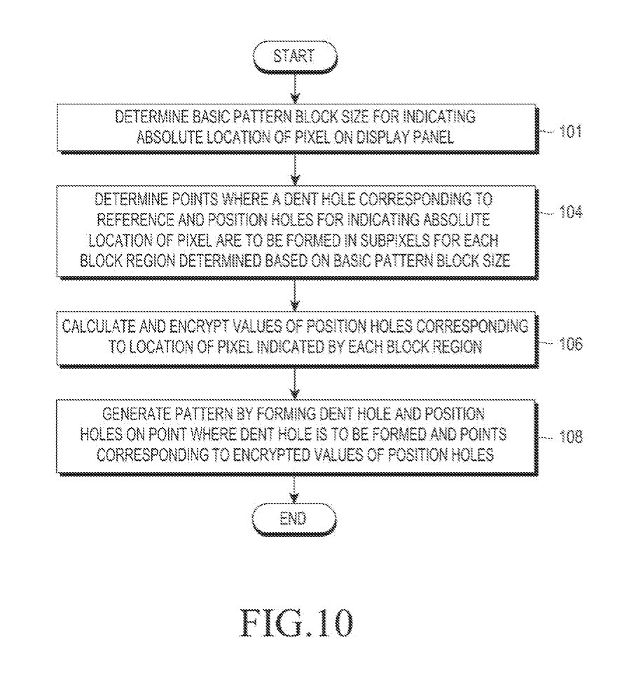

FIG. 10 is flow chart illustrating a process for generating a pattern in a display apparatus according to an embodiment of the present invention.

Referring to FIG. 10, the display apparatus according to an embodiment of the present invention determines a basic pattern block size required for obtaining an absolute location of a single pixel on a display panel in step 101. For example, to obtain the absolute location of the single pixel, a pattern indicating the absolute location of the pixel may be formed on a plurality of pixels (for example, 2×2 pixels). In this example, a size of the plurality of pixels where the pattern is formed to obtain the absolute location of the pixel may be referred to as the basic pattern block size.

When the basic pattern block size is determined as described above, the display apparatus determines points where a dent hole corresponding to a reference and position holes for indicating the absolute location of the pixel are to be formed in subpixels for each block region in step 104. Points where parity holes for checking an error of the position holes for indicating the absolute location of the pixel are to be formed may also be determined.

For example, when the basic pattern block size is 2×2 pixels (including 12 subpixels), a point for a dent hole corresponding to a single subpixel for indicating a reference to be used for calculating an absolute location value of the pixel may be determined. Also, points for 7 position holes may be determined in 8 subpixels through use of 7 septenary numbers (X0, X1, X2, X3, Y1, Y2, and Y3) and one quaternary number (Y0) as an X coordinate value and a Y coordinate value. Points for 7 parity holes may be determined in remaining 3 subpixels so as to check an error of the position holes.

When the points where the dent hole and the position holes are to be formed are determined for each block region, the display apparatus calculates values of the position holes corresponding to the location of the pixel to be indicated by each block region, and encrypts the calculated values in step 106. For 2×2 pixels (including 12 subpixels), values of position holes to be formed in 8 subpixels (X0, X1, X2, X3, Y1, Y2, Y3, and Y0) may be obtained using Equation (1) and Equation (2), so as to indicate the location of the pixel (an X coordinate value and a Y coordinate value). Also, when the values of the position holes are obtained, the values of the position holes may be converted into encrypted values based on a shuffle table that is described in the foregoing.

When the values of the position holes are calculated and encrypted, the display apparatus forms the dent hole and the position holes on the point where the dent hole is to be formed and points corresponding to the encrypted values of the position holes, and generates a pattern indicating the location of the pixel in step 108. Parity holes may also be formed and may be included in the pattern so as to check errors.

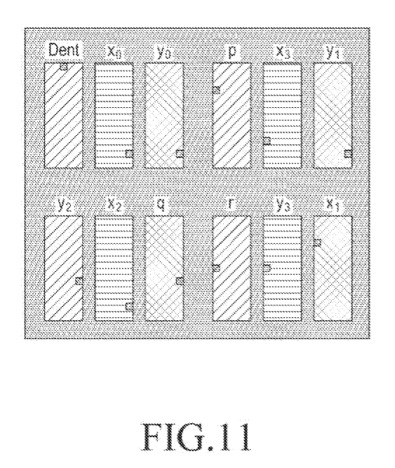

FIG. 11 illustrates an example of a pattern formed to indicate a location of a pixel in a display apparatus according to an embodiment of the present invention. Specifically, FIG. 11 illustrates a pattern when values of X0, X1, X2, X3, Y1, Y2, Y3, and Y0 (encrypted values of position holes) correspond to X0=3, X1=0, X2=3, X3=2, Y0=3, Y1=3, Y2=4, and Y3=1, respectively, and values of p, q, and r (values of parity holes) correspond to p=0, q=4, and r=1, respectively.

As described above, the pattern generated according to embodiments of the present invention may be recognized by an input device including a camera, e.g., an electronic-pen, and a location of a corresponding pixel may be detected. Accordingly, input operations may be performed based on the detected location value of the pixel.

According to the above-described embodiments of the present invention, input operations are performed by forming a pattern indicating a location of a pixel in subpixels of a display apparatus and thus, a display panel does not affect a thickness of the display apparatus as opposed to a digital paper, and luminance and a contrast ratio of a display screen may be secured.

According to the above-described embodiments of the present invention, a pattern for indicating a location of a pixel is formed in subpixels of a display apparatus based on a number of predetermined holes and locations of the holes, and location information of the pixel is represented, in order to provide a display apparatus having a large size and a high resolution.

According to the above-described embodiments of the present invention, when a portion of a pattern is lost or has an error, error checking may be performed.

According to the above-described embodiments of the present invention, a pattern is formed based on an encrypted value in order to prevent the pattern from being decrypted without permission, and preventing the leakage of technology associated with the pattern.

Further, although the embodiments of the present invention have been described above based on a 2×2 pixel-based pattern structure for example, various pixel-based pattern structures may be used, and although a shuffle table is used in the embodiments of the present invention, a different encrypting scheme for converting a value of each hole may be applicable.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A display apparatus, the apparatus comprising:
a plurality of color filters corresponding to subpixels forming pixels of the display apparatus; and
a black matrix formed among the plurality of color filters,
wherein the plurality of color filters includes a pattern indicating an absolute location of each pixel of the display apparatus.

2. The apparatus of claim 1, wherein the pattern indicating the absolute location of each pixel is generated when a plurality of holes are formed in a region of the plurality of color filters corresponding to the subpixels forming the pixels.

3. The apparatus of claim 2, wherein the plurality of holes comprises:
a dent hole indicating a reference for calculating an absolute location of a corresponding pixel; and
position holes for calculating a horizontal-axis coordinate value of the corresponding pixel and a vertical-axis coordinate value of the corresponding pixel.

4. The apparatus of claim 3, wherein the position holes are formed on points indicating values to be used for calculating the horizontal-axis coordinate value of the corresponding pixel and the vertical-axis coordinate value of the corresponding pixel in the region of the plurality of color filters.

5. The apparatus of claim 4, wherein the plurality of holes further comprises parity holes to be used for checking for errors of the position holes.

6. The apparatus of claim 5, wherein the parity holes are formed on points indicating values to be used for checking for errors of the points where the position holes are formed.

7. The apparatus of claim 6, wherein the values corresponding to the points where the plurality of holes are formed are encrypted based on a predetermined shuffle table, and
wherein the plurality of holes are formed on points indicating the encrypted values.

8. The apparatus of claim 3, wherein the plurality of holes are formed by leading a material identical to a material of a region of the black matrix into the color filter region.

9. The apparatus of claim 1, wherein the plurality of color filters comprises:
an R color filter;
a G color filter; and
a B color filter.

10. A method for generating a pattern in a display apparatus, the method comprising:
determining a basic pattern block size to indicate an absolute location of a pixel on a display panel of the display apparatus;
determining points where a plurality of holes are to be formed in subpixels included in each block region determined based on the basic pattern block size, where the plurality of holes are used for calculating an absolute location of a corresponding pixel; and
generating the pattern by forming a corresponding hole in each point based on an absolute location of a pixel included in each block region, among the points where the plurality of holes are to be formed.

11. The method of claim 10, wherein the plurality of holes includes a dent hole indicating a reference for calculating an absolute location of a corresponding pixel, and position holes to be used for calculating a horizontal-axis coordinate value of the corresponding pixel and a vertical-axis coordinate value of the corresponding pixel.

12. The method of claim 11, wherein the plurality of holes further includes parity holes for checking errors of the position holes.

13. The method of claim 12, wherein determining the points where the plurality of holes are to be formed comprises:
determining a point where the dent hole is to be formed; and
determining points where the position holes are to be formed.

14. The method of claim 13, wherein determining the points where the plurality of holes are to be formed further comprises:
determining points where the parity holes indicating values to be used for determining whether the points for the position holes are correct, are to be formed.

15. The method of claim 14, wherein determining the points where the plurality of holes are to be formed comprises:
encrypting the determined points based on a predetermined shuffle table, and forming the plurality of holes on points indicating encrypted values.
